(19) United States
(12) Patent Application Publication
(10) Pub. No.: US 2024/0364923 A1
(43) Pub. Date: Oct. 31, 2024

(54) COMPRESSION METHOD, CODING METHOD AND DEVICE OF VIDEO CODING REFERENCE BLOCK

(71) Applicant: ZHUHAI JIELI TECHNOLOGY CO., LTD., Zhuhai, Guangdong (CN)

(72) Inventors: Jun Wang, Zhuhai, Guangdong (CN); Jianxin Yang, Zhuhai, Guangdong (CN); Cong Luo, Zhuhai, Guangdong (CN); Fan Liang, Zhuhai, Guangdong (CN); Kai Huang, Zhuhai, Guangdong (CN)

(21) Appl. No.: 18/560,111

(22) PCT Filed: Mar. 21, 2022
(86) PCT No.: PCT/CN2022/081947

§ 371 Date: Nov. 10, 2023

(30) Foreign Application Priority Data
Jul. 22, 2021 (CN) 202110829913.4

(51) Int. Cl. H04N 19/593; H04N 19/105; H04N 19/119; H04N 19/136; H04N 19/176; H04N 19/182; H04N 19/42

(52) U.S. Cl. CPC H04N 19/593; H04N 19/105; H04N 19/119; H04N 19/136; H04N 19/176; H04N 19/182; H04N 19/42

(57) ABSTRACT

The present application discloses a compression method, a coding method, a compression device and a coding device for a video coding reference block, including: step S000: dividing the reference block into several pixel blocks; step S100: selecting a pixel block; step S200: directly saving the original pixel value of each pixel in the first region; step S300: performing horizontal DPCM prediction on each pixel in the second region and calculating same to obtain a predictive residual, and performing vertical DPCM prediction on each pixel in the third region and calculating same to obtain a predictive residual; and step S400: obtaining for each pixel in the fourth region a predictive value and a predictive residual according to a pixel value relationship of several neighborhood pixels in the horizontal direction and the vertical direction.

### TECHNICAL FIELD

The present application relates to video coding and decoding technology, in particular to a compression method, a coding method, a compression device and a coding device suitable for a reference block in HEVC video coding.

### BACKGROUND

With the continuous development of multimedia digital video applications, the volume of a raw video data collected by image sensors or generated by computers is growing too rapidly for the existing transmission network bandwidth and storage resources to bear. At present, the video coding (also known as video compression) technology is generally used to compress the raw video, and the data volume of the raw video is compressed while minimizing the loss of picture quality to reduce the video bit rate, i.e., the number of data bits transmitted per unit time during data transmission. At present, according to the video coding and decoding standards, the H.26X series is led by the International Telecommunication Union (ITU). Among them, a High Efficiency Video Coding (HEVC/H.265) is a new video compression standard, and compared with the previous generation of an Advanced Video Coding (AVC/H.264), the HEVC has a significant improvement in video compression (the same quality of coded video can save 40-50% of the bit rate), and improves the parallel mechanism and network input mechanism.

As applications of screen content video increase, such as in game broadcasting, on-line education and teleconferencing, and screen content shows different statistical characteristics from natural content, HEVC introduced Screen Content Coding (SCC) and developed a series of new coding techniques for characteristics of screen content, so that the coding efficiency of screen content video is further improved. Since screen content video generally includes computer-generated image content such as text, graphics, charts and icons, and natural image content photographed by a camera, which belongs to a type of video formed by mixing natural and computer-generated images, the screen content video is generally in a case such as irregular movement of objects, abrupt scene changes, sharper image edges and flatter and monotonic areas, and the existing rate control method for natural video content is not suitable for SCC, because it does not fully utilize the characteristics of the screen content video, resulting in low image compression efficiency.

In order to improve the pixel block prediction effect, SCC based on the HEVC framework introduces a plurality of coding tools, in which Intra Block Replication or Intra Block Copy (IBC) contributes most. IBC is similar to inter prediction, except that the reference pixels of IBC are from the reconstructed pixels of the same frame (before loop filtering). IBC introduces an idea of motion estimation and motion compensation for inter prediction into intra prediction, and a coding unit in HEVC is a basic unit for predictive coding. When coding the current CU, a pixel block closer in content to the current CU is searched from the decoded reconstruction area of the current frame as a reference block, i.e., used as a predictive value of the current CU, and a Block Vector (BV) is used to indicate the displacement from the reference block to the current CU. Since the screen content video has more repeating patterns than the natural content video, IBC achieves higher coding efficiency. IBC can use the complete current frame as a reference area, i.e., full frame search, and thus IBC also brings an additional memory bandwidth requirement, i.e., the reconstructed pre-filtered image of the current frame needs to be stored in off-chip memory for use in motion estimation and motion compensation of the IBC technique.

Therefore, existing video coding techniques under the HEVC framework place higher demands on the memory bandwidth of video compression systems. Codec chip and off-chip memory need to exchange reference frame or reference block data frequently, resulting in occupying a large amount of memory bus bandwidth. For example, traditional edge prediction relies on left-to-right, top-to-bottom pixel-pixel traversal prediction, which is computationally complex. In the inter prediction process of video coding techniques, the reference frame access already occupies a large amount of memory access bandwidth, especially when the new IBC technology introduced by HEVC's SCC coding tool needs to access a large amount of reference block data of the current frame, and this process will lead to a more serious memory bandwidth problem.

### SUMMARY

Accordingly, a major object of the present application is to provide a compression method, a coding method, a compression device and a coding device for a video coding reference block. Under the framework of HEVC video coding and decoding, the correlation between adjacent pixels in a reference block is used to obtain an optimal predictive value for each pixel, thereby obtaining a predictive residual of each pixel and coding and outputting a code stream, and the memory bandwidth resource required when accessing the reference block can be effectively reduced through compression processing on the reference block.

In order to achieve the above object, the technical solution adopted by the present application is as follows:

according to a first aspect of the present application, provided is a compression method for a video coding reference block for performing intra prediction for the video coding using intra block replication, and acquiring the reference block from a reconstruction area where a current frame can be used for intra block replication, the compression method including the following steps:

step S000: dividing the reference block into several pixel blocks, each pixel block including several pixels;

step S100: selecting a pixel block, and dividing several pixels of the pixel block into a first region, a second region, a third region and a fourth region of the pixel block, the first region being a pixel at the top left corner of the pixel block, the second region referring to all the pixels of the first row of the pixel block excluding the first region, the third region referring to all the pixels of the first column of the pixel block excluding the first region, and the fourth region referring to all the pixels remaining after the first region, the second region and the third region are cut out from the pixel block;

step S200: directly saving original pixel values of the pixels in the first region;

step S300: performing horizontal DPCM prediction on each pixel in the second region to obtain a predictive value of the pixel, and calculating a difference between an original pixel value and the predictive value of the pixel to obtain a predictive residual of the pixel; performing vertical DPCM prediction on each pixel in the third region to obtain a predictive value of the pixel, and calculating a difference between an original pixel value and the predictive value of the pixel to obtain a predictive residual of the pixel;

step S400: selecting, for each pixel in the fourth region respectively, several neighborhood pixels of the pixel according to a sequence from left to right and from top to bottom, and obtaining a predictive value of the pixel according to a pixel value relationship of the several neighborhood pixels in a horizontal direction and a vertical direction, and calculating a difference between an original pixel value and the predictive value of the pixel to obtain a predictive residual of the pixel; and repeating the steps S100 to S400 until the processing of all the pixel blocks is completed.

Preferably, the step S400 includes:

step S410, selecting four neighborhood pixels of a currently to-be-processed pixel, the neighborhood pixels being successively located at a left side, an upper left side, an upper side and an upper right side of the currently to-be-processed pixel, and acquiring pixel values of the neighborhood pixels being successively r₁, r₂, r₃ and r₄;

step S420: obtaining a horizontal gradient and a vertical gradient of the currently to-be-processed pixel according to the following relational expression:

$${G}_{x} = {r}_{3} - {r}_{2}$$

$${G}_{y} = {r}_{1} - {r}_{2}$$

where Gₓ is a horizontal gradient of the currently to-be-processed pixel, and G_{y} is a vertical gradient of the currently to-be-processed pixel;

step S430: obtaining a horizontal component and a vertical component of the currently to-be-processed pixel according to the following relational expression:

Dₓ=G_{y}

D_{y}=Gₓ

where Dₓ is a horizontal component of the currently to-be-processed pixel, and D_{y} is a vertical component of the currently to-be-processed pixel;

step S440: obtaining a predictive value of the currently to-be-processed pixel according to the following relational expression:

$$x = \{ \begin{matrix}{r}_{4} , & if ( \vert {D}_{x} \vert >> 1 ) < \vert {D}_{y} \vert \leq ( \vert {D}_{x} \vert << 1 ) \& s = 0 \\ {r}_{3} , & if \vert {D}_{y} \vert > ( \vert {D}_{x} \vert << 1 ) \\ {r}_{2} , & if ( \vert {D}_{x} \vert >> 1 ) < \vert {D}_{y} \vert \leq ( \vert {D}_{x} \vert << 1 ) \& s = 1 \\ {r}_{1} , & if \vert {D}_{y} \vert \leq ( \vert {D}_{x} \vert >> 1 )\end{matrix} ,$$

$$where s = {D}_{x} ⊕ {D}_{y}$$

where x is a predictive value of the currently to-be-processed pixel, |Dₓ| and |D_{y}| are an absolute value of a horizontal component and an absolute value of a vertical component of the currently to-be-processed pixel respectively, (|Dₓ|>>1) is a result of performing a binary right shift operation on |Dₓ|, (|Dₓ|<<1) is a result of performing a binary left shift operation on |Dₓ|, Dₓ⊕D_{y} is performing an exclusive-OR operation on the positive and negative of Dₓ and D_{y}, and s is a result of the exclusive-OR operation.

Preferably, in the step S440, when the currently to-be-processed pixel is located in the rightmost column of the fourth region, then r₄=r₃.

Preferably, in the step S420, the currently to-be-processed pixel and the pixels on the left side, the upper left side and the upper side thereof constitute a matrix, a first modified Roberts operator is used to perform convolution on the matrix to obtain a horizontal gradient of the currently to-be-processed pixel, and a second modified Roberts operator is used to perform convolution on the matrix to obtain a vertical gradient of the currently to-be-processed pixel;

the first modified Roberts operator is:

$${M}_{x} = [ \begin{matrix}- 1 & 1 \\ 0 & 0\end{matrix} ]$$

the second modified Roberts operator is:

$${M}_{y} = [ \begin{matrix}- 1 & 0 \\ 1 & 0\end{matrix} ]$$

Preferably, in the step S100, the pixel block includes M*N pixels;

in the step S300,

the horizontal DPCM prediction is that the predictive values of the 1^{st} to (M−1)^{th} pixels in the second region are pixel values of pixels on the left side thereof, respectively;

the vertical DPCM prediction is that the reconstructed pixel values of the 1^{st} to (N−1)^{th} pixels of the third region are the pixel values of the upper pixels thereof, respectively.

According to a second aspect of the present application, provided is a video coding method for performing intra prediction using intra block replication, and acquiring a reference block from a reconstruction area where a current frame can be used for intra block replication, the method including the following steps:

obtaining a predictive residual of each pixel in the second region, the third region and the fourth region of each pixel block by using the compression method described in the above first aspect, and then coding the original pixel value of the pixel in the first region and the predictive residual of each pixel in the second region, the third region and the fourth region of each pixel block, and outputting a code stream to be stored into off-chip memory; and

reading a code stream from the off-chip memory and decoding same to obtain a reconstructed reference block for intra prediction of a current frame coding unit when it is necessary to access the reference block.

According to a third aspect of the present application, provided is a compression device for a video coding reference block for performing intra prediction for the video coding using intra block replication, the compression device including:

a blocking module configured to acquire the reference block from a reconstruction area where a current frame can be used for intra block replication, and divide the reference block into several pixel blocks, each pixel block including several pixels;

a partition module configured to divide each pixel block into a first region, a second region, a third region and a fourth region, the first region being a pixel at the top left corner of the pixel block, the second region referring to all the pixels of the first row of the pixel block excluding the first region, the third region referring to all the pixels of the first column of the pixel block excluding the first region, and the fourth region referring to all the pixels remaining after the first region, the second region and the third region are cut out from the pixel block;

a first prediction module configured to directly save original pixel values of the pixels in the first region;

a second prediction module configured to perform horizontal DPCM prediction on each pixel in the second region and obtain a predictive value of the pixel;

a third prediction module configured to perform vertical DPCM prediction on each pixel in the third region and obtain a predictive value of the pixel;

a fourth prediction module configured to sequentially select several neighborhood pixels of each pixel in the fourth region according to a sequence from left to right and from top to bottom, and obtain a predictive value of the pixel according to a pixel value relationship of several neighborhood pixels of the pixel in a horizontal direction and a vertical direction; and

a calculation module configured to calculate a predictive residual of each pixel in the second region, the third region and the fourth region, the predictive residual being a difference between the original pixel value and the predictive value for each pixel.

Preferably, the fourth prediction module includes:

a neighborhood pixel selection sub-module configured to select four neighborhood pixels of a currently to-be-processed pixel, the neighborhood pixels being successively located at a left side, an upper left side, an upper side and an upper right side of the pixel, and acquire pixel values of the neighborhood pixels being successively r₁, r₂, r₃ and r₄;

a gradient calculation sub-module configured to calculate and obtain the horizontal gradient and the vertical gradient of the currently to-be-processed pixel, and obtain the horizontal gradient and the vertical gradient of the pixel according to the following relational expression:

$${G}_{x} = {r}_{3} - {r}_{2} {G}_{y} = {r}_{1} - {r}_{2}$$

where Gₓ is a horizontal gradient of the currently to-be-processed pixel, and G_{y} is a vertical gradient of the currently to-be-processed pixel;

a component comparison sub-module configured to calculate and obtain the horizontal component and the vertical component of the currently to-be-processed pixel, and obtain the horizontal component and the vertical component of the pixel according to the following relational expression:

Dₓ=G_{y}

D_{y}=Gₓ

where Dₓ is a horizontal component of the currently to-be-processed pixel, and D_{y} is a vertical component of the currently to-be-processed pixel;

the component comparison sub-module is further configured to calculate and compare the horizontal component and the vertical component of the currently to-be-processed pixel and obtain a predictive value of the pixel, and obtain the predictive value of the pixel according to the following relational expression:

$$x = \{ \begin{matrix}{r}_{4} , & if ( \vert {D}_{x} \vert >> 1 ) < \vert {D}_{y} \vert \leq ( \vert {D}_{x} \vert << 1 ) \& s = 0 \\ {r}_{3} , & if \vert {D}_{y} \vert > ( \vert {D}_{x} \vert << 1 ) \\ {r}_{2} , & if ( \vert {D}_{x} \vert >> 1 ) < \vert {D}_{y} \vert \leq ( \vert {D}_{x} \vert << 1 ) \& s = 1 \\ {r}_{1} , & if \vert {D}_{y} \vert \leq ( \vert {D}_{x} \vert >> 1 )\end{matrix} ,$$

$$where s = {D}_{x} ⊕ {D}_{y}$$

where x is a predictive value of the currently to-be-processed pixel, |Dₓ| and |D_{y}| are an absolute value of a horizontal component and an absolute value of a vertical component of the currently to-be-processed pixel respectively, (|Dₓ|>>1) is a result of performing a binary right shift operation on |Dₓ|, (|Dₓ|<<1) is a result of performing a binary left shift operation on |Dₓ|, Dₓ D_{y} is performing an exclusive-OR operation on the positive and negative of Dₓ and D_{y}, and s is a result of the exclusive-OR operation.

Preferably, the gradient calculation sub-module includes a convolution operator for convolution operation of a matrix and an operator;

the matrix is composed of each pixel in the fourth region and neighborhood pixels located at the left side, the upper left side and the upper side of the pixel;

the operator includes:

the first modified Roberts operator is:

$${M}_{x} = [ \begin{matrix}- 1 & 1 \\ 0 & 0\end{matrix} ]$$

the second modified Roberts operator is:

$${M}_{y} = [ \begin{matrix}- 1 & 0 \\ 1 & 0\end{matrix} ]$$

preferably, the component comparison sub-module includes:

a bit operator configured to perform a binary left shift operation and a binary right shift operation on the horizontal component and the vertical component;

an exclusive-OR operator configured to perform an exclusive-OR operation on the positive and negative of the horizontal component and the vertical component;

a comparison operator configured to determine a magnitude relationship between numerical values.

According to a fourth aspect of the present application, provided is a video coding device for performing intra prediction using intra block replication, and acquiring a reference block from a reconstruction area where a current frame can be used for intra block replication, and the video coding device includes the compression device for a video coding reference block described in the above third aspect, and further includes:

a coding module configured to output a code stream after performing variable-length coding on an original pixel value of a pixel in a first region and a predictive residual of each pixel in a second region, a third region and a fourth region of each pixel block.

According to a fifth aspect of the present application, provided is a chip for performing the compression method for a video coding reference block described in the above first aspect or the video coding method described in the above second aspect.

According to a sixth aspect of the present application, provided is a computer-readable storage medium having stored thereon a computer program for operating to implement the compression method for a video coding reference block described in the first aspect or the video coding method described in the second aspect.

For the compression method and compression device for a video coding reference block of the present application, firstly, by dividing the reference block into several pixel blocks, compression processing can be performed on each pixel block at the same time to improve the compression processing efficiency of the reference block. Secondly, a per-pixel adaptive prediction mechanism of a pixel block is established by using the correlation between adjacent pixels in the image, especially based on the pixel edge texture information obtained from the change of pixel values provided by neighborhood pixels to obtain a more accurate predictive value for each pixel, and then taking the difference between the original pixel value and the predictive value for each pixel as the predictive residual of each pixel, and coding and outputting the code stream, the pixel block is effectively compressed after such per-pixel adaptive prediction, which can reduce the spatial redundancy of the pixel block image, have good compression efficiency, and ensure lossless image compression, thus can reduce the memory bandwidth required to access the reference block, and ease the memory bus bandwidth load of HEVC video coding and decoding. Further, the compression method of the present application can effectively save bit rate and reduce the memory bus bandwidth occupancy without using an additional flag bit to record the predictive direction of each pixel to obtain a predictive value.

According to the video coding method and coding device of the present application, using the above compression method and compression device for a video coding reference block can effectively reduce the data volume of the reference block, the bit rate of an output code stream of the reference block after compression is significantly reduced, and when a codec chip exchanges reference block data with an off-chip memory, the usage amount of memory bandwidth resources can be reduced, which is helpful to improving the processing efficiency of video coding and reducing the occupancy of memory resources.

The chip of the present application is used for executing the compression method for a video coding reference block or the video coding method, can realize the compression processing of the reference block and ensure good operation efficiency, which helps to reduce the consumption of memory bandwidth resources in the video coding process.

For the computer-readable storage medium of the present application, the computer program stored thereon is used for running to implement the compression method for a video coding reference block or the video coding method, so that the memory bandwidth resource required for accessing the reference block in the video coding process is significantly reduced, which helps to improve the video coding efficiency.

Further beneficial effects of the present application will be set forth in the detailed description through introduction of the specific technical features and technical solutions, and the beneficial technical effects brought by the technical features and technical solutions should be understood by a person skilled in the art through the introduction of the technical features and technical solutions.

### BRIEF DESCRIPTION OF THE DRAWINGS

Preferred implementations of the compression method for a video coding reference block according to the present application will be described with reference to the accompanying drawings. In the drawings:

FIG. 1 is a schematic diagram of a flow of the compression method for a video coding reference block according to the present application;

FIG. 2 is a schematic diagram of the structure of a pixel block according to the present application, (2a) is a schematic diagram of a pixel of the pixel block, and (2b) is a schematic diagram of regions of the pixel block;

FIG. 3 is a schematic diagram of a neighborhood pixel, a horizontal gradient, a vertical gradient, a horizontal component and a vertical component according to the present application, and (3a) is a schematic diagram of four neighborhood pixels of a pixel x; (3b) is a schematic diagram of an edge direction of a pixel x; (3c) is a schematic diagram of a horizontal component and a vertical component; and (3d) is a schematic diagram of a horizontal gradient and a vertical gradient; and

FIG. 4 is a computational example of the compression method for a video coding reference block according to the present application.

### DETAILED DESCRIPTION

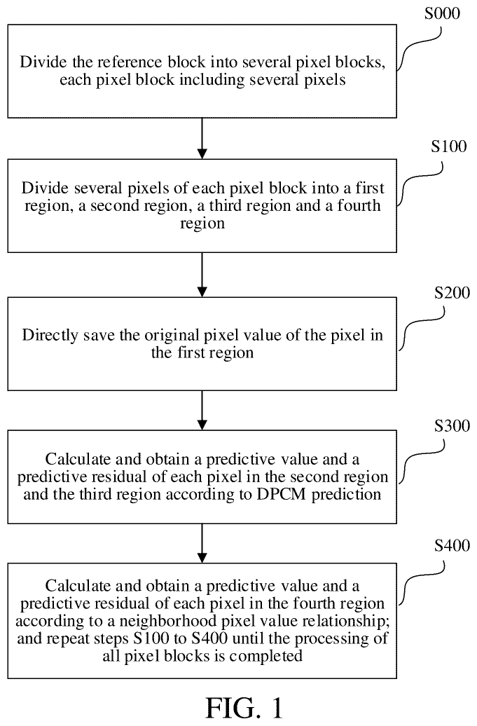

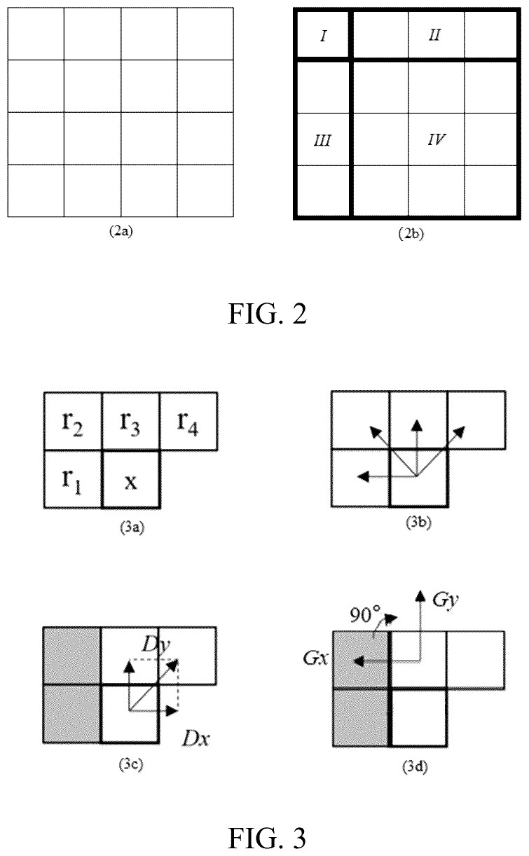

Referring to FIG. 1, the present application provides a compression method for a video coding reference block for performing intra prediction for the video coding using intra block replication, and acquiring the reference block from a reconstruction area where a current frame can be used for intra block replication, the compression method including the following steps:

Step S000: dividing the reference block into several pixel blocks, each pixel block including several pixels, and the pixel referring to a minimum unit in the image represented by the number sequence. An object of the step is to further divide the reference block into smaller processing units, and to perform compression processing on a plurality of pixel blocks simultaneously to improve the compression processing efficiency of the reference block. The size of the reference block itself is based on meeting the use requirements of a Coding Unit (CU), the number of pixel blocks divided in the reference block can be determined according to actual video coding and decoding conditions, and is generally determined by the compression effect obtained through experimental tests combined with an acceptable hardware design cost, and both the compression performance and the hardware cost need to be considered.

Step S100: selecting a pixel block, and dividing several pixels of the pixel block into a first region, a second region, a third region and a fourth region of the pixel block, the first region being a pixel at the top left corner of the pixel block, the second region referring to all the pixels of the first row of the pixel block excluding the first region, the third region referring to all the pixels of the first column of the pixel block excluding the first region, and the fourth region referring to all the pixels remaining after the first region, the second region and the third region are cut out from the pixel block. For example, referring to (2a), a certain pixel block includes 4×4 pixels, and referring to (2b), the bold lines in the figure indicate that these pixels respectively constitute a first region (part I in the figure), a second region (part II in the figure), a third region (part III in the figure) and a fourth region (part IV in the figure) of the pixel block.

Step S200: directly saving the original pixel value of the pixel in the first region, i.e., this pixel in the top left corner of the pixel block is not predicted and compressed, as the data basis for the whole pixel block compression processing.

Step S300: performing horizontal DPCM prediction on each pixel in the second area to obtain a predictive value of the pixel, and calculating a difference between an original pixel value and the predictive value of the pixel to obtain a predictive residual of the pixel; performing vertical DPCM prediction on each pixel in the third region to obtain a predictive value of the pixel, and calculating the difference between an original pixel value and the predictive value of the pixel to obtain a predictive residual of the pixel.

DPCM prediction, i.e., differential predictive coding, uses the correlation between adjacent pixels in an image to take the pixel value of the previous pixel as the predictive value of the currently to-be-processed pixel, and then takes the difference between the original pixel value and the predictive value of the currently to-be-processed pixel as the predictive residual, and codes the predictive residual, thereby improving the compression efficiency of the image. It should be noted that since DPCM cannot obtain the original pixel value at the decoding end, but obtains the pixel value based on the predictive residual, when predicting the currently to-be-processed pixel, the pixel value after the previous pixel has been decoded and reconstructed (except for the pixel in the first region, the pixel value thereof is the original pixel value) is used, i.e., the sum of the predictive value of the previous pixel and the predictive residual. In addition, the conventional DPCM generally includes the integer quantization process, which may cause some quantization error and result in lossy image compression. Therefore, a quantizer is not used in the horizontal DPCM and vertical DPCM to avoid quantization error and ensure lossless image compression.

Step S400: selecting, for each pixel in the fourth region respectively, several neighborhood pixels of the pixel according to a sequence from left to right and from top to bottom, and obtaining a predictive value of the pixel according to a pixel value change relationship of the neighborhood pixels in a horizontal direction and a vertical direction, and calculating a difference between an original pixel value and the predictive value of the pixel to obtain a predictive residual of the pixel.

Repeating the steps S100 to S400 until the processing of all the pixel blocks is completed.

Through the above steps, on the basis that the original pixel value of the pixels in the first region is the data basis of the whole pixel block compression processing, each pixel in the second region, the third region and the fourth region is predicted to obtain an optimal predictive value to obtain the predictive residual of each pixel in the second region, the third region and the fourth region; after completing the processing of all the pixel blocks, by coding these predictive residuals, a fairly good compression effect can be achieved, so that the data volume of the reference block is significantly reduced to reduce the occupancy of memory bandwidth resources when reading and writing the reference block in the video coding process. In addition, in a video coding process, after a reference block is processed by the compression method, the compression degree of the data volume thereof varies according to the size and position of the reference block and the number of pixel blocks in the reference block, and when satisfying a certain compression performance and the data volume of the compressed reference block, the compressed reference block can be considered to be stored in an on-chip cache to improve the data read-write efficiency of accessing the reference block.

As an alternative example, referring to FIG. 3, the step S400 specifically includes:

Step S410, referring to (3a), selecting four neighborhood pixels of the currently to-be-processed pixel x, the neighborhood pixels being successively located at a left side, an upper left side, an upper side and an upper right side of the pixel, and acquiring pixel values of the four neighborhood pixels being successively r₁, r₂, r₃ and r₄. It should be noted that since the original pixel values cannot be obtained at the decoding end, these pixel values used for the prediction of the currently to-be-processed pixel are also the decoded and reconstructed pixel values, rather than the original pixel values (except for the pixels in the first region, the pixel values thereof are original pixel values).

This step is to use a strong correlation between adjacent pixels in an image, i.e., usually the image has a large spatial redundancy; generally, the predictive value of the currently to-be-processed pixel can be directly selected from a plurality of adjacent pixels thereof; therefore, considering the compression method using the difference of the adjacent pixels and the availability of the adjacent pixels, these four adjacent pixels of the currently to-be-processed pixel are taken as the prediction basis of the pixel, referring to (3b).

Since an edge referred to in an image is a part where the size of a pixel value changes sharply, edge texture information about the currently to-be-processed pixel needs to be obtained from the pixel value change relationship of these four neighborhood pixels, and then a predictive direction of the pixel is determined to obtain an optimal predictive value. According to the direction of the edge being perpendicular to the direction in which the pixel value changes in size, i.e., perpendicular to the direction in which the pixel value gradient changes, referring to (3c) and (3d), the horizontal gradient Gₓ and the vertical gradient G_{y} of the currently to-be-processed pixel are obtained through calculation, and the horizontal component for representing the direction of the texture edge of the region adjacent to the currently to-be-processed pixel is defined as the horizontal component Dₓ of the currently to-be-processed pixel, the vertical component for representing the direction of the texture edge of the region adjacent to the currently to-be-processed pixel is the vertical component D_{y} of the currently to-be-processed pixel, and the horizontal component Dₓ of the currently to-be-processed pixel is equal to the vertical gradient G_{y}, and the vertical component D_{y} of the currently to-be-processed pixel is equal to the horizontal gradient Gₓ, i.e. the following steps S420 and S430.

Step S420: obtaining a horizontal gradient and a vertical gradient of the currently to-be-processed pixel according to the following relational expression:

$${G}_{x} = {r}_{3} - {r}_{2}$$

$${G}_{y} = {r}_{1} - {r}_{2}$$

where Gₓ is a horizontal gradient of the currently to-be-processed pixel, and G_{y} is a vertical gradient of the currently to-be-processed pixel.

Step S430: obtaining a horizontal component and a vertical component of the currently to-be-processed pixel according to the following relational expression:

Dₓ=G_{y}

D_{y}=Gₓ

where Dₓ is a horizontal component of the currently to-be-processed pixel, and D_{y} is a vertical component of the currently to-be-processed pixel.

Step S440: obtaining a predictive value of the currently to-be-processed pixel according to the following relational expression:

$$x = \{ \begin{matrix}{r}_{4} , & if ( \vert {D}_{x} \vert >> 1 ) < \vert {D}_{y} \vert \leq ( \vert {D}_{x} \vert << 1 ) \& s = 0 \\ {r}_{3} , & if \vert {D}_{y} \vert > ( \vert {D}_{x} \vert << 1 ) \\ {r}_{2} , & if ( \vert {D}_{x} \vert >> 1 ) < \vert {D}_{y} \vert \leq ( \vert {D}_{x} \vert << 1 ) \& s = 1 \\ {r}_{1} , & if \vert {D}_{y} \vert \leq ( \vert {D}_{x} \vert >> 1 )\end{matrix} ,$$

$$where s = {D}_{x} ⊕ {D}_{y}$$

where x is a predictive value of the pixel, |Dₓ| and |D_{y}| are an absolute value of a horizontal component and an absolute value of a vertical component of the pixel respectively, (|Dₓ|>>1) is a result of performing a binary right shift operation on |Dₓ|, (|Dₓ|<<1) is a result of performing a binary left shift operation on |Dₓ|, Dₓ⊕D_{y} is performing an exclusive-OR operation on the positive and negative of Dₓ and D_{y}, and s is a result of the exclusive-OR operation. The binary right shift is equivalent to dividing a logarithmic value by 2, and the binary left shift is equivalent to multiplying the logarithmic value by 2; and in terms of hardware implementation, the efficiency of the binary right shift and left shift operations is higher than that of the division and multiplication operations.

In the step S440, on the basis of obtaining the horizontal component and the vertical component of the currently to-be-processed pixel through the steps S420 and S430, the horizontal component and the vertical component are calculated and compared to determine an optimal predictive value of the currently to-be-processed pixel, and the edge texture information of the pixel is fully used, thereby realizing a per-pixel adaptive prediction mechanism.

Through the above steps, the compression method of the present application obtains edge texture information about a to-be-processed pixel by changing pixel values of neighborhood pixels, and determines an optimal predictive value of the currently to-be-processed pixel by calculating and comparing a horizontal component and a vertical component of the currently to-be-processed pixel, thereby converting the problem of finding an optimal predictive value into an edge direction problem; at the same time, a left shift operation and a right shift operation in a binary bit operation have a high operation efficiency, are easy to implement in a hardware chip, and save resource consumption compared with a numerical multiplication and division method, so that hardware implementation costs are lower and operation efficiency is higher.

As an alternative example, in the step S440, if the currently to-be-processed pixel is located in the rightmost column of the fourth region, then r₄=r₃. This is because, for the pixels of the rightmost column in the fourth region, the neighborhood pixels on the upper right side thereof are not available, and thus the pixel values of the neighborhood pixels on the upper side thereof are taken as predictive values.

As an alternative example, in the step S420, the currently to-be-processed pixel and the pixels on the left side, the upper left side and the upper side thereof constitute a matrix, a first modified Roberts operator is used to perform convolution on the matrix to obtain a horizontal gradient of the currently to-be-processed pixel, and a second modified Roberts operator is used to perform convolution on the matrix to obtain a vertical gradient of the currently to-be-processed pixel.

In the step, in order to reduce the complexity of gradient calculation, pixel matrix and operator are used to perform convolution operation to improve the operation efficiency. The Roberts operator is a simple and easy-to-use operator, and is an operator that uses local difference operator to find edges. The Roberts operator is generally expressed as follows:

$${M}_{x}^{′} = [ \begin{matrix}- 1 & 0 \\ 0 & 1\end{matrix} ]$$

$${M}_{y}^{′} = [ \begin{matrix}0 & - 1 \\ 1 & 0\end{matrix} ]$$

since the pixel value at the lower right corner during compression processing is the original pixel value of the currently to-be-processed pixel, which cannot be obtained at the decoding end, in order to ensure the consistency of coding and decoding, the above Roberts operator is modified as follows:

a first modified Roberts operator configured to calculate a horizontal gradient of a currently to-be-processed pixel, expressed as follows:

$${M}_{x} = [ \begin{matrix}- 1 & 1 \\ 0 & 0\end{matrix} ]$$

a second Roberts operator configured to calculate a vertical gradient of a currently to-be-processed pixel, expressed as follows:

$${M}_{y} = [ \begin{matrix}- 1 & 0 \\ 1 & 0\end{matrix} ]$$

Specifically, the currently to-be-processed pixel and the pixels on the left side, the upper left side and the upper side thereof constitute a matrix, as shown below:

$$Img = [ \begin{matrix}{r}_{2} & {r}_{3} \\ {r}_{1} & x\end{matrix} ]$$

Thus, the horizontal component and the vertical component of the currently to-be-processed pixel can be obtained by the following calculation process:

$$\{ \begin{matrix}{D}_{y} & = {G}_{x} = Img \times {M}_{x} = {r}_{3} - {r}_{2} \\ {D}_{x} & = {G}_{y} = Img \times {M}_{y} = {r}_{1} - {r}_{2}\end{matrix}$$

As a basic processing method of digital image processing, the convolution operation of pixel matrix and operator can significantly reduce the volume of pixel gradient calculation and help to improve the efficiency of reference block compression processing, and the modified Roberts operator is more suitable for the reference block compression processing method using the change of pixel values of neighborhood pixels.

As an alternative example, in the step S100: the pixel block includes M*N pixels, and M and N can take the same value.

In the step S300, horizontal DPCM prediction refers to that the predictive values of the 1^{st} to M−1th pixels in the second region are pixel values of pixels on the left side thereof, respectively, and vertical DPCM prediction refers to that the predictive values of the 1^{st} to (N−1)^{th} pixels in the third region are pixel values of pixels on the upper side thereof, respectively. Thus, a simple and fast prediction is performed for each pixel of the second region and the third region in the pixel block, which is easy to implement and ensures lossless image compression.

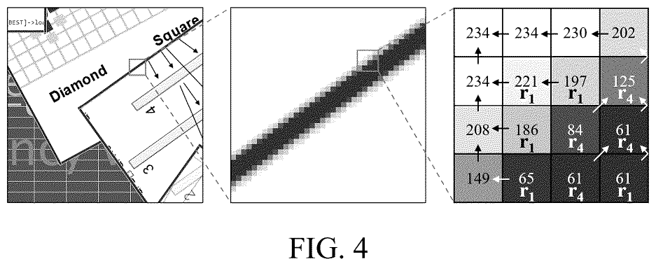

Referring to FIG. 4, the pixel block is taken from a 4×4 luminance block of FlyingGraphics which is one of the common video test sequences for measuring the performance of an algorithm specified in the process of formulating an HEVC standard, and this is taken as a calculation example; the number in the figure is a specific pixel value of each pixel, and an arrow indicates the predictive direction of each pixel, i.e., the predictive value of the pixel is a pixel value of a neighborhood pixel indicated by the arrow, for example, pixels in the second column of the second row are Dₓ=0 and D_{y}=0, and x is obtained from the step S440 and taken as r₁; as another example, the pixels in the fourth column of the second row are Dₓ=−33. D_{y}=−28, and x is obtained from the step S440 and taken as r₄, and since the upper right neighborhood pixel of the pixel is not available, x is taken as r₃. Thus, the compression method of the present application can quickly and effectively obtain the predictive value for each pixel in the fourth region, and can achieve a better compression effect.

The present application further provides a video coding method for performing intra prediction using intra block replication, and acquiring a reference block from a reconstruction area where a current frame can be used for intra block replication, and the reference block is divided into several pixel blocks, each pixel block including several pixels.

The video coding method includes the following steps: calculating and obtaining a predictive residual of each pixel in the second region, the third region and the fourth region of each pixel block by using the compression method for a video coding reference block described in the above examples, and then coding the original pixel value of the pixel in the first region and the predictive residual of each pixel in the second region, the third region and the fourth region of each pixel block, and outputting a code stream to be stored into off-chip memory. The coding method is variable-length coding to code pixel information in all the pixel blocks after compression processing to obtain a code stream containing the whole reference block after compression processing.

A code stream is read from an off-chip memory and decoded to obtain a reconstructed reference block for intra block replication of a current frame coding unit when it is necessary to access the reference block.

With the video coding method, based on the above compression method for a video coding reference block, an optimal predictive value of the pixel is obtained using a pixel value change relationship of the neighborhood pixels, so that the reference block is compressed based on a reconstructed pixel value, which is helpful to reducing the load on memory bandwidth when accessing the reference block and reducing resource consumption.

The present application further provides a compression device for a video coding reference block for performing intra prediction for the video coding using intra block replication, the compression device including a blocking module, a partitioning module, a first prediction module, a second prediction module, a third prediction module, a fourth prediction module and a calculation module.

Specifically, the blocking module is configured to acquire the reference block from a reconstruction area where the current frame can be used for intra block replication, and divide the reference block into several pixel blocks, each pixel block including several pixels.

A partition module is configured to divide each pixel block into a first region, a second region, a third region and a fourth region, the first region being a pixel at the top left corner of the pixel block, the second region referring to all the pixels of the first row of the pixel block excluding the first region, the third region referring to all the pixels of the first column of the pixel block excluding the first region, and the fourth region referring to all the pixels remaining after the first region, the second region and the third region are cut out from the pixel block. With such partition processing, it is possible to adopt respective suitable prediction methods for different regions in each pixel block, take pixels in the first region as a data basis for predicting the entire pixel block, then perform compression processing on pixels in the second region and pixels in the third region, and then perform compression processing on pixels in the fourth region.

A first prediction module is configured to directly save original pixel values of the pixels in the first region.

A second prediction module is configured to perform horizontal DPCM prediction on each pixel in the second region and obtain a predictive value of the pixel. Horizontal DPCM prediction refers to that the predictive value of the currently to-be-processed pixel is the pixel value of the pixel on the left side thereof.

The third prediction module is configured to perform vertical DPCM prediction on each pixel in the third region and obtain a predictive value of the pixel. Vertical DPCM prediction refers to that the predictive value of the currently to-be-processed pixel is the pixel value of the pixel on the upper side thereof.

A fourth prediction module is configured to sequentially select several neighborhood pixels of each pixel in the fourth region according to a sequence from left to right and from top to bottom, and obtain a predictive value of the pixel according to a pixel value relationship of several neighborhood pixels of the pixel in a horizontal direction and a vertical direction.

A calculation module configured to calculate a predictive residual of each pixel in the second region, the third region and the fourth region, the predictive residual being a difference between the original pixel value and the predictive value for each pixel.

The compression device for a video coding reference block of the present application can achieve a per-pixel adaptive prediction mechanism by performing blocking and partition processing on the reference block, using the correlation between adjacent pixels, and respectively using an appropriate prediction method to obtain a predictive value of a pixel for different regions in each pixel block, and a good compression efficiency can be obtained after the reference block is processed by the compression device, and lossless image compression is ensured.

As an alternative example, the fourth prediction module includes a neighborhood pixel selection sub-module, a gradient calculation sub-module and a component comparison sub-module.

The neighborhood pixel selection sub-module is configured to select four neighborhood pixels of a currently to-be-processed pixel, the neighborhood pixels being successively located at a left side, an upper left side, an upper side and an upper right side of the pixel, and acquire pixel values of the neighborhood pixels being successively r₁, r₂, r₃ and r₄.

The gradient calculation sub-module is configured to calculate and obtain the horizontal gradient and the vertical gradient of the currently to-be-processed pixel, and obtain the horizontal gradient and the vertical gradient of the pixel according to the following relational expression:

$${G}_{x} = {r}_{3} - {r}_{2}$$

$${G}_{y} = {r}_{1} - {r}_{2}$$

where Gₓ is a horizontal gradient of the currently to-be-processed pixel, and G_{y} is a vertical gradient of the currently to-be-processed pixel.

The component comparison sub-module is configured to calculate a horizontal component and a vertical component of a currently to-be-processed pixel, and calculate and compare the horizontal component and the vertical component of the pixel and obtain a predictive value of the pixel.

Specifically, the component comparison sub-module obtains the horizontal component and the vertical component of the currently to-be-processed pixel according to the following relational expression:

Dₓ=G_{y}

D_{y}=Gₓ

where Dₓ is a horizontal component of the currently to-be-processed pixel, and D_{y} is a vertical component of the currently to-be-processed pixel;

Specifically, the component comparison sub-module obtains the predictive value of the currently to-be-processed pixel according to the following relational expression:

$$x = \{ \begin{matrix}{r}_{4} , & if ( \vert {D}_{x} \vert >> 1 ) < \vert {D}_{y} \vert \leq ( \vert {D}_{x} \vert << 1 ) \& s = 0 \\ {r}_{3} , & if \vert {D}_{y} \vert > ( \vert {D}_{x} \vert << 1 ) \\ {r}_{2} , & if ( \vert {D}_{x} \vert >> 1 ) < \vert {D}_{y} \vert \leq ( \vert {D}_{x} \vert << 1 ) \& s = 1 \\ {r}_{1} , & if \vert {D}_{y} \vert \leq ( \vert {D}_{x} \vert >> 1 )\end{matrix} , where s = {D}_{x} ⊕ {D}_{y}$$

where x is a predictive value of the currently to-be-processed pixel, |Dₓ| and |D_{y}| are an absolute value of a horizontal component and an absolute value of a vertical component of the currently to-be-processed pixel respectively, (|Dₓ|>>1) is a result of performing a binary right shift operation on |Dₓ|, (|Dₓ|<<1) is a result of performing a binary left shift operation on |Dₓ|, Dₓ⊕D_{y} is performing an exclusive-OR operation on the positive and negative of Dₓ and D_{y}, and s is a result of the exclusive-OR operation.

Thus, a neighborhood pixel of a currently to-be-processed pixel and a corresponding pixel value thereof are obtained through a neighborhood pixel selection sub-module, then a horizontal gradient and a vertical gradient of the currently to-be-processed pixel are obtained through a gradient calculation sub-module, and then a horizontal component and a vertical component of the currently to-be-processed pixel are obtained through a component comparison sub-module and are calculated and compared to determine an optimal predictive value of the currently to-be-processed pixel.

As an alternative example, the gradient calculation sub-module includes a convolution operator for convolution operation of a matrix and an operator. The matrix is composed of each pixel in the fourth region and neighborhood pixels located on the left side, the upper left side and the upper side of the pixel.

The operators include a first modified Roberts operator and a second modified Roberts operator configured to calculate a horizontal gradient and a vertical gradient, respectively, of the currently to-be-processed pixel.

The first modified Roberts operator is expressed as follows:

$${M}_{x} = [ \begin{matrix}- 1 & 1 \\ 0 & 0\end{matrix} ]$$

The second modified Roberts operator is expressed as follows:

$${M}_{y} = [ \begin{matrix}- 1 & 0 \\ 1 & 0\end{matrix} ]$$

As an alternative example, the component comparison sub-module includes a bit operator, an exclusive-OR operator and a comparison operator.

The bit operator is used for performing a binary left shift operation and a binary right shift operation on the horizontal component and the vertical component;

the exclusive-OR operator is used for performing an exclusive-OR operation on the positive and negative of the horizontal component and the vertical component; and

the comparison operator is used for determining a magnitude relationship between numerical values.

Thus, the component comparison sub-module can support calculating and comparing the horizontal component and the vertical component of each pixel to obtain an optimal predictive value of the pixel, and in particular, the bit operator can implement a binary left shift operation and a right shift operation on the horizontal component and the vertical component, which is easier to implement in hardware and has high operation efficiency.

The present application further provides a video coding device for performing intra prediction using intra block replication, and acquiring a reference block from a reconstruction area where a current frame can be used for intra block replication, the video coding device including the compression device for a video coding reference block according to the above examples, and further including:

a coding module configured to output a code stream after performing variable-length coding on an original pixel value of a pixel in a first region and a predictive residual of each pixel in a second region, a third region and a fourth region of each pixel block.

The present application further provides a chip for performing the compression method for a video coding reference block described in the above examples or the video coding method described in the above examples.

The present application further provides a computer-readable storage medium having stored thereon a computer program for executing the compression method for a video coding reference block of the above examples or the video coding method of the above examples.

It should be noted that the use of step numbers (letter or number) in the present application to refer to certain specific method steps is merely for convenience and brevity of description and is in no way intended to limit the order of the method steps by letters or numbers. It will be clear to a person skilled in the art that the order of the relevant method steps should be determined by the technique itself and should not be unduly limited by the presence of step numbers.

It will be understood by a person skilled in the art that the above preferred solutions may be freely combined and stacked without conflict.

It is to be understood that the above implementations are merely illustrative and not restrictive, and that various obvious or equivalent modifications or substitutions made to the above details by a person skilled in the art without departing from the basic principles of the present application all fall in the scope of the claims of the present application.

1. A compression method for a video coding reference block for performing intra prediction for the video coding using intra block replication, and acquiring the reference block from a reconstruction area where a current frame can be used for intra block replication, wherein the compression method comprises the following steps:
step S000: dividing the reference block into several pixel blocks, each pixel block comprising several pixels;
step S100: selecting a pixel block, and dividing several pixels of the pixel block into a first region, a second region, a third region and a fourth region of the pixel block, the first region being a pixel at the top left corner of the pixel block, the second region referring to all the pixels of the first row of the pixel block excluding the first region, the third region referring to all the pixels of the first column of the pixel block excluding the first region, and the fourth region referring to all the pixels remaining after the first region, the second region and the third region are cut out from the pixel block;
step S200: directly saving original pixel values of the pixels in the first region;
step S300: performing horizontal DPCM prediction on each pixel in the second region to obtain a predictive value of the pixel, and calculating a difference between an original pixel value and the predictive value of the pixel to obtain a predictive residual of the pixel; performing vertical DPCM prediction on each pixel in the third region to obtain a predictive value of the pixel, and calculating a difference between an original pixel value and the predictive value of the pixel to obtain a predictive residual of the pixel;
step S400: selecting, for each pixel in the fourth region respectively, several neighborhood pixels of the pixel according to a sequence from left to right and from top to bottom, and obtaining a predictive value of the pixel according to a pixel value relationship of the several neighborhood pixels in a horizontal direction and a vertical direction, and calculating a difference between an original pixel value and the predictive value of the pixel to obtain a predictive residual of the pixel; and
repeating the steps S100 to S400 until the processing of all the pixel blocks is completed.

2. The compression method for a video coding reference block according to claim 1, wherein the step S400 comprises:
step S410, selecting four neighborhood pixels of a currently to-be-processed pixel, the neighborhood pixels being successively located at a left side, an upper left side, an upper side and an upper right side of the currently to-be-processed pixel, and acquiring pixel values of the neighborhood pixels being successively r₁, r₂, r₃ and r₄;
step S420: obtaining a horizontal gradient and a vertical gradient of the currently to-be-processed pixel according to the following relational expression:
$${G}_{x} = {r}_{3} - {r}_{2}$$
$${G}_{y} = {r}_{1} - {r}_{2}$$
where Gₓ is a horizontal gradient of the currently to-be-processed pixel, and G_{y} is a vertical gradient of the currently to-be-processed pixel;
step S430: obtaining a horizontal component and a vertical component of the currently to-be-processed pixel according to the following relational expression:
Dₓ=G_{y}
D_{y}=Gₓ
where Dₓ is a horizontal component of the currently to-be-processed pixel, and D_{y} is a vertical component of the currently to-be-processed pixel;
step S440: obtaining a predictive value of the currently to-be-processed pixel according to the following relational expression:
$$x = \{ \begin{matrix}{r}_{4} , & if ( \vert {D}_{x} \vert >> 1 ) < \vert {D}_{y} \vert \leq ( \vert {D}_{x} \vert << 1 ) \& s = 0 \\ {r}_{3} , & if \vert {D}_{y} \vert > ( \vert {D}_{x} \vert << 1 ) \\ {r}_{2} , & if ( \vert {D}_{x} \vert >> 1 ) < \vert {D}_{y} \vert \leq ( \vert {D}_{x} \vert << 1 ) \& s = 1 \\ {r}_{1} , & if \vert {D}_{y} \vert \leq ( \vert {D}_{x} \vert >> 1 )\end{matrix} , where s = {D}_{x} ⊕ {D}_{y}$$
where x is a predictive value of the currently to-be-processed pixel, |Dₓ| and |D_{y}| are an absolute value of a horizontal component and an absolute value of a vertical component of the currently to-be-processed pixel respectively, (|Dₓ|>>1) is a result of performing a binary right shift operation on |Dₓ|, (|Dₓ|<<1) is a result of performing a binary left shift operation on |Dₓ|, Dₓ⊕D_{y} is performing an exclusive-OR operation on the positive and negative of Dₓ and D_{y}, and s is a result of the exclusive-OR operation.

3. The compression method for a video coding reference block according to claim 2, wherein in the step S440, when the currently to-be-processed pixel is located in the rightmost column of the fourth region, then r₄=r₃.

4. The compression method for a video coding reference block according to claim 2, wherein in the step S420, the currently to-be-processed pixel and the pixels on the left side, the upper left side and the upper side thereof constitute a matrix, a first modified Roberts operator is used to perform convolution on the matrix to obtain a horizontal gradient of the currently to-be-processed pixel, and a second modified Roberts operator is used to perform convolution on the matrix to obtain a vertical gradient of the currently to-be-processed pixel;
the first modified Roberts operator is:
$${M}_{x} = [ \begin{matrix}- 1 & 1 \\ 0 & 0\end{matrix} ]$$
the second modified Roberts operator is:
$${M}_{y} = [ \begin{matrix}- 1 & 0 \\ 1 & 0\end{matrix} ]$$

5. A compression method for a video coding reference block according to claim 1, wherein
in the step S100, the pixel block comprises M*N pixels;
in the step S300,
the horizontal DPCM prediction is that the predictive values of the 1^{st} to (M−1)^{th} pixels in the second region are pixel values of pixels on the left side thereof, respectively;
the vertical DPCM prediction is that the reconstructed pixel values of the 1^{st} to (N−1)^{th} pixels of the third region are the pixel values of the upper pixels thereof, respectively.

6. A video coding method for performing intra prediction using intra block replication, and acquiring a reference block from a reconstruction area where a current frame can be used for intra block replication, wherein the method comprises the following steps:
obtaining a predictive residual of each pixel in the second region, the third region and the fourth region of each pixel block by using the compression method according to claim 1, and then coding the original pixel value of the pixel in the first region and the predictive residual of each pixel in the second region, the third region and the fourth region of each pixel block, and outputting a code stream to be stored into off-chip memory; and
reading a code stream from the off-chip memory and decoding same to obtain a reconstructed reference block for intra prediction of a current frame coding unit when it is necessary to access the reference block.

7. A compression device for a video coding reference block for performing intra prediction for the video coding using intra block replication, wherein the compression device comprises:
a blocking module configured to acquire the reference block from a reconstruction area where a current frame can be used for intra block replication, and divide the reference block into several pixel blocks, each pixel block comprising several pixels;
a partition module configured to divide each pixel block into a first region, a second region, a third region and a fourth region, the first region being a pixel at the top left corner of the pixel block, the second region referring to all the pixels of the first row of the pixel block excluding the first region, the third region referring to all the pixels of the first column of the pixel block excluding the first region, and the fourth region referring to all the pixels remaining after the first region, the second region and the third region are cut out from the pixel block;
a first prediction module configured to directly save original pixel values of the pixels in the first region;
a second prediction module configured to perform horizontal DPCM prediction on each pixel in the second region and obtain a predictive value of the pixel;
a third prediction module configured to perform vertical DPCM prediction on each pixel in the third region and obtain a predictive value of the pixel;
a fourth prediction module configured to sequentially select several neighborhood pixels of each pixel in the fourth region according to a sequence from left to right and from top to bottom, and obtain a predictive value of the pixel according to a pixel value relationship of several neighborhood pixels of the pixel in a horizontal direction and a vertical direction; and
a calculation module configured to calculate a predictive residual of each pixel in the second region, the third region and the fourth region, the predictive residual being a difference between the original pixel value and the predictive value for each pixel.

8. The compression device according to claim 7, wherein the fourth prediction module comprises:
a neighborhood pixel selection sub-module configured to select four neighborhood pixels of a currently to-be-processed pixel, the neighborhood pixels being successively located at a left side, an upper left side, an upper side and an upper right side of the pixel, and acquire pixel values of the neighborhood pixels being successively r₁, r₂, r₃ and r₄;
a gradient calculation sub-module configured to calculate and obtain the horizontal gradient and the vertical gradient of the currently to-be-processed pixel, and obtain the horizontal gradient and the vertical gradient of the pixel according to the following relational expression:
$${G}_{x} = {r}_{3} - {r}_{2}$$
$${G}_{y} = {r}_{1} - {r}_{2}$$
where Gₓ is a horizontal gradient of the currently to-be-processed pixel, and G_{y} is a vertical gradient of the currently to-be-processed pixel;
a component comparison sub-module configured to calculate and obtain the horizontal component and the vertical component of the currently to-be-processed pixel, and obtain the horizontal component and the vertical component of the pixel according to the following relational expression:
Dₓ=G_{y}
D_{y}=Gₓ
where Dₓ is a horizontal component of the currently to-be-processed pixel, and D_{y} is a vertical component of the currently to-be-processed pixel;
the component comparison sub-module is further configured to calculate and compare the horizontal component and the vertical component of the currently to-be-processed pixel and obtain a predictive value of the pixel, and obtain the predictive value of the pixel according to the following relational expression:
$$x = \{ \begin{matrix}{r}_{4} , & if ( \vert {D}_{x} \vert >> 1 ) < \vert {D}_{y} \vert \leq ( \vert {D}_{x} \vert << 1 ) \& s = 0 \\ {r}_{3} , & if \vert {D}_{y} \vert > ( \vert {D}_{x} \vert << 1 ) \\ {r}_{2} , & if ( \vert {D}_{x} \vert >> 1 ) < \vert {D}_{y} \vert \leq ( \vert {D}_{x} \vert << 1 ) \& s = 1 \\ {r}_{1} , & if \vert {D}_{y} \vert \leq ( \vert {D}_{x} \vert >> 1 )\end{matrix} , where s = {D}_{x} ⊕ {D}_{y}$$
where x is a predictive value of the currently to-be-processed pixel, |Dₓ| and |D_{y}| are an absolute value of a horizontal component and an absolute value of a vertical component of the currently to-be-processed pixel respectively, (|Dₓ|>>1) is a result of performing a binary right shift operation on |Dₓ|, (|Dₓ|<<1) is a result of performing a binary left shift operation on |Dₓ|, Dₓ ⊕D_{y} is performing an exclusive-OR operation on the positive and negative of Dₓ and D_{y}, and s is a result of the exclusive-OR operation.

9. The compression device according to claim 8, wherein the gradient calculation sub-module comprises a convolution operator for convolution operation of a matrix and an operator;
the matrix is composed of each pixel in the fourth region and neighborhood pixels located at the left side, the upper left side and the upper side of the pixel;
the operator comprises:
the first modified Roberts operator is:
$${M}_{x} = [ \begin{matrix}- 1 & 1 \\ 0 & 0\end{matrix} ]$$
the second modified Roberts operator is:
$${M}_{y} = [ \begin{matrix}- 1 & 0 \\ 1 & 0\end{matrix} ] .$$

10. The compression device according to claim 8, wherein the component comparison sub-module comprises:
a bit operator configured to perform a binary left shift operation and a binary right shift operation on the horizontal component and the vertical component;
an exclusive-OR operator configured to perform an exclusive-OR operation on the positive and negative of the horizontal component and the vertical component;
a comparison operator configured to determine a magnitude relationship between numerical values.

11. (canceled)

12. A chip, wherein the chip is used for executing the compression method for a video coding reference block according to claim 1.

13. A computer-readable storage medium having stored thereon a computer program, wherein the computer program is operative to implement the compression method for a video coding reference block according to claim 1.

14. A chip, wherein the chip is used for executing the video coding method according to claim 6.

15. A computer-readable storage medium having stored thereon a computer program, wherein the computer program is operative to implement the video coding method according to claim 6.
